(19) United States
(12) Patent Application Publication
(10) Pub. No.: US 2015/0033175 A1
(43) Pub. Date: Jan. 29, 2015

(54) PORTABLE DEVICE

(71) Applicant: ASUSTeK COMPUTER INC., Taipei (TW)

(72) Inventors: I-Hsi WU, Taipei (TW); Wen-Chieh TSENG, Taipei (TW); Shu-Hui CHOU, Taipei (TW)

(21) Appl. No.: 14/336,445

(22) Filed: Jul. 21, 2014

Related U.S. Application Data
(60) Provisional application No. 61/857,413, filed on Jul. 23, 2013.

(30) Foreign Application Priority Data
Jun. 4, 2014 (TW) 103209799

(51) Int. Cl. G06F 3/0484; G06F 3/0488; G06F 3/0481

(52) U.S. Cl. CPC G06F 3/04842; G06F 3/0481; G06F 3/0488
USPC 715/771

(57) ABSTRACT

A portable device is provided. The portable device includes a touch control module, a display module, a memory module and a processing unit. The display module is connected to the touch control module. The processing unit is connected to the touch control module and the memory module. The display module displays a home frame. The memory module stores an application program. When the portable device executes the application program, the display module displays a shrunken frame and a control area. The control area surrounds the shrunken frame, and the shrunken frame is the zoom-out home frame. The portable device can be held and operated by a single hand.

### CROSS-REFERENCE TO RELATED APPLICATION

This application claims the priority benefit of U.S. provisional application Ser. No. 61/857,413, filed on Jul. 23, 2013 and Taiwan application serial no. 103209799, filed on Jun. 4, 2014. The entirety of the above-mentioned patent applications are hereby incorporated by reference herein and made a part of specification.

### BACKGROUND OF THE INVENTION

1. Field of the Invention

The invention relates to a portable device.

2. Description of the Related Art

As science technology develops, a display screen of a portable device becomes larger. However, according to statistic data, when the size of the display screen is larger than 4 inches, partial area of the display screen is difficult to be touched by thumb if the device is held by one single hand, which is inappropriate for single-hand operation. Conventionally, some icons can be placed within a “hot zone” where is easily accessible by thumb when the device is held by one single hand.

### BRIEF SUMMARY OF THE INVENTION

A portable device for single-hand holding and operating is provided.

The portable device includes a touch control module, a display module, a memory module and a processing unit. The display module is connected to the touch control module. The processing unit is connected to the touch control module and the memory module.

The display module displays a home frame. The memory module stores an application program. When the portable device executes the application program, the display module displays a shrunken frame and a control area. The control area surrounds the shrunken frame, and the shrunken frame is a zoom-out home frame.

These and other features, aspects and advantages of the present invention will become better understood with regard to the following description, appended claims, and accompanying drawings.

### BRIEF DESCRIPTION OF THE DRAWINGS

FIG. 1 is a block diagram showing a portable device in the first embodiment;

FIG. 2 is a schematic diagram showing a home frame displayed by a portable device in the first embodiment;

FIG. 3 is a schematic diagram showing a portable device and a graphic interface in the first embodiment;

FIG. 4 is a schematic diagram showing the portable device of FIG. 3 in use;

FIG. 5 is another schematic diagram showing the portable device of FIG. 3 in use; and

FIG. 6 is a schematic diagram showing a portable device and a graphic interface in the second embodiment.

### DETAILED DESCRIPTION OF THE EMBODIMENTS

A portable device with a graphic user interface (GUI) is illustrated with relating drawing, and the same number denotes the same component.

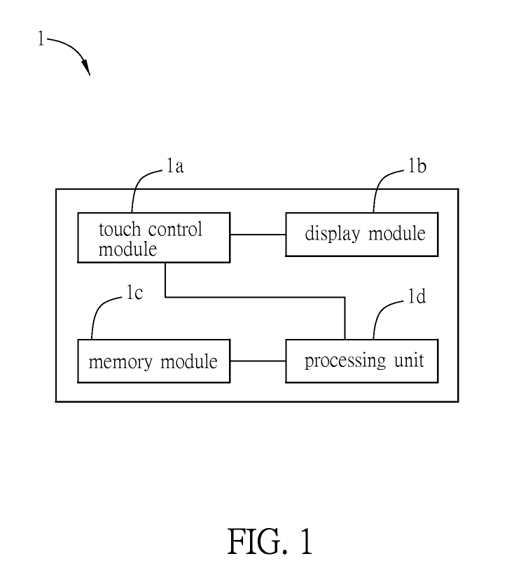

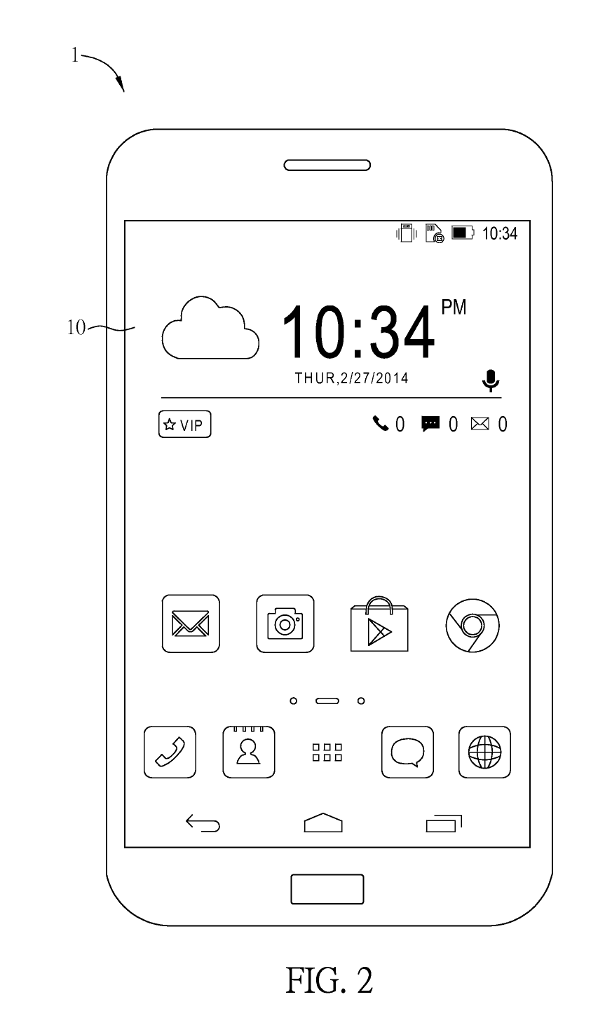

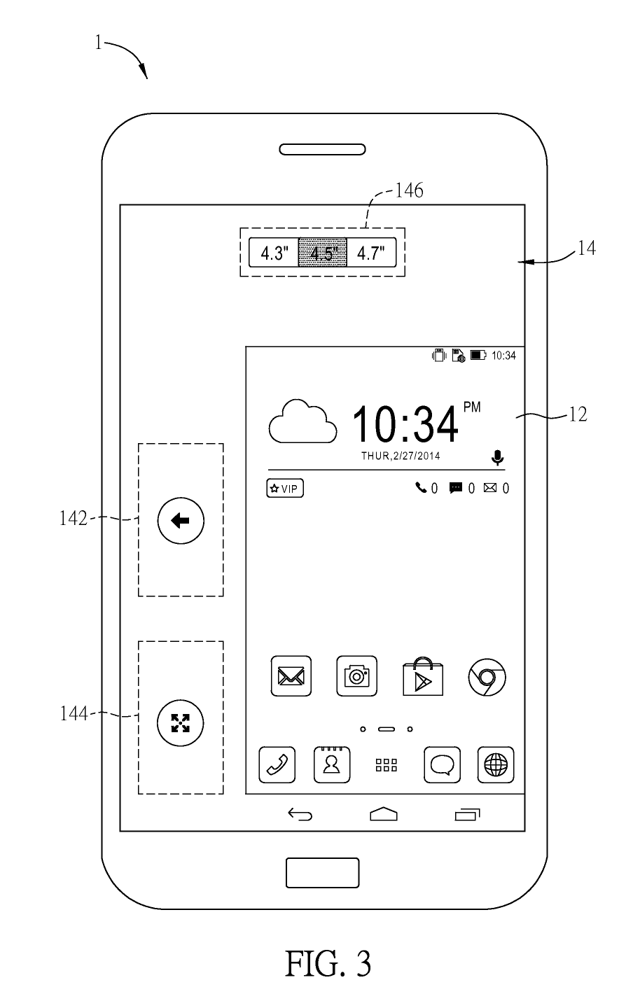

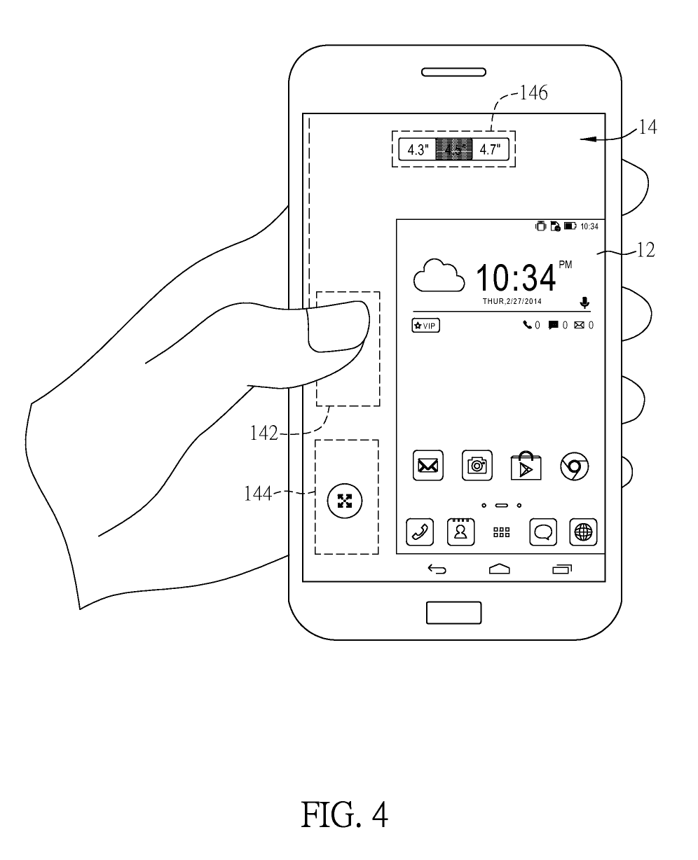

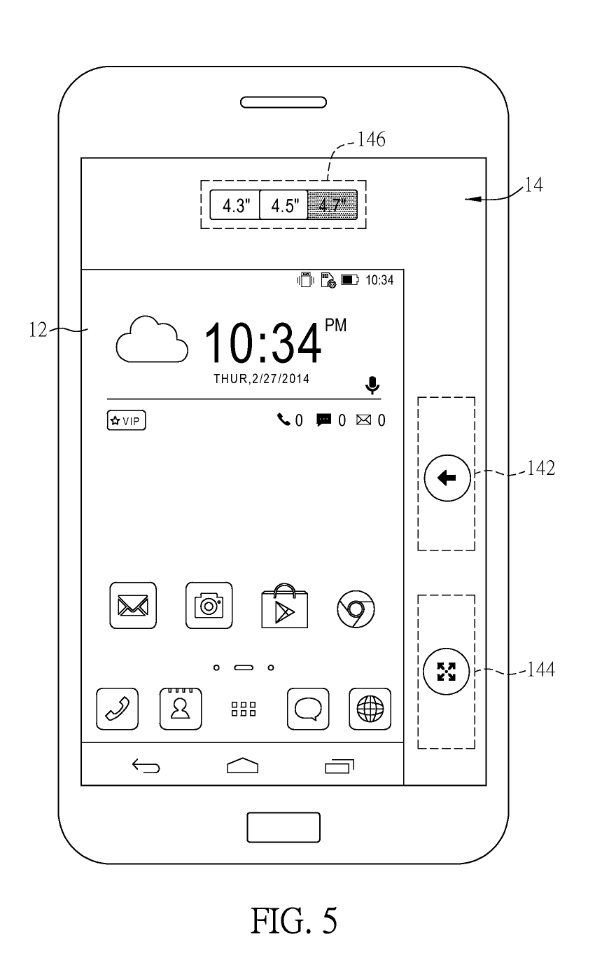

Please refer to FIG. 1 to FIG. 5, FIG. 1 is a block diagram showing a portable device in the first embodiment, FIG. 2 is a schematic diagram showing a home frame displayed by a portable device in the first embodiment, FIG. 3 is a schematic diagram showing a portable device and a graphic interface in the first embodiment, FIG. 4 and FIG. 5 are schematic diagrams showing the portable device of FIG. 3 in use.

In the embodiment, a graphic user interface (GUI) applied for an application program for single-hand holding is disclosed. The application program can be executed by a portable device 1.

Please refer to FIG. 1, the portable device 1 includes a touch control module 1a, a display module 1b, a memory module 1c and a processing unit 1d. The display module 1b is connected to the touch control module 1a. The processing unit 1d is connected to the touch control module 1a and the memory module 1c. The application program is stored in the memory module 1c. The portable device 1 may be a mobile phone (such as a smart phone), a tablet computer, a notebook computer (such as an ultrabook) or a personal digital assistant (PDA), which is not limited herein.

In the following embodiment, the portable device 1 is a smart phone (which is also called a smart mobile phone) as an example. The smart phone includes an operating system, and the application program (such as an App program) may be installed by default, or is downloaded and stored in the memory module of the phone by users. In an embodiment, the application program is downloaded from the manufacturers, which is not limited herein.

When the portable device 1 is in normal use (which means the application program is not executed), the display module lb displays a home frame 10 (as shown in FIG. 2). When the application program is to be executed, the user can click a corresponding icon at the home frame 10 or enter a system setting page of the portable device to execute the application program, and then the portable device enters a single-hand holding mode.

Please refer to FIG. 3, when the application program is executed, the display module lb of the portable device 1 displays a shrunken frame 12 and a control area 14. The shrunken frame 12 is the zoom-out home frame 10. The control area 14 surrounds the shrunken frame 12 (for example, in the embodiment, the control area 14 is arranged in L-shape around the shrunken frame 12). The shrunken frame 12 may be displayed at a corner of a displaying frame of the portable device 1 for single-hand operating. The configuration and the control options of the control area 14 is just an example, and the number of the control options can be increased or reduced according to requirements, which is not limited herein.

In the embodiment, the shrunken frame 12 is displayed at the right bottom of the home frame 10. When the application program is executed, the home frame 10 is displayed under the shrunken frame 12 as a background, or the home frame is blurred or covered.

Moreover, when the user clicks outside the shrunken frame 12 or outside the control area 14, the touch control module la automatically corrects the clicking position to a nearest position at the shrunken frame 12. When the user uses a finger to slide from the upper edge of the home frame 10, a pull-down menu or a pull-down window shows. However, if the user wants to execute the function via a similar gesture at the shrunken frame 12, the clicking position needs to be corrected. Thus, the gesture is easy to be detected, and a similar pull-down menu or a pull-down window shows at the shrunken frame 12.

In the embodiment, “an input event” means an inputting action received by the touch control module la of the portable device 1. For example, the input event may be an action that clicking an icon at the displaying frame, thus, a corresponding program code is called, and a corresponding command is transmitted to the processing unit 1d.

In the embodiment, the control area 14 includes a first control area 142. The first control area 142 may be a dominant hand switching area, which means the position of the shrunken frame 12 at the displaying frame of the display module lb can be adjusted via the first control area 142 according to a using habit. For example, if the dominant hand is the right hand, the shrunken frame 12 is set at the right position via the first control area 142.

In detail, when the touch control module la receives the input event on the first control area 142, such as clicking an icon (which is an arrow icon as shown in FIG. 3) at the first control area 142, the processing unit 1d provides a switch signal accordingly and the configuration of the shrunken frame 12 and the control area 14 is adjusted. That means, after the shrunken frame 12 moves towards the left side, the control area 14 is adjusted accordingly and locate around the shrunken frame (as shown in FIG. 5).

Furthermore, the control area 14 further includes a second control area 144. The second control area 144 may be a single-hand mode exiting area, and the user can exit the single-hand mode to restore the home frame via the second control area 144 (as shown in FIG. 2).

In detail, after the touch control module la receives the input event at the second control area 144, the processing unit 1d generates an exit signal according to the input event, and the shrunken frame 12 and the control area 14 are not displayed. At the moment, the display module 1b only displays the home frame 10 (as shown in FIG. 2).

In the embodiment, the control area 14 further includes a third control area 146. The third control area is a frame size adjusting area, and it is for adjusting the size of the shrunken frame 12 according to users' requirements. In the embodiment, the third control area 146 provides at least three different sizes of frame for selection, such as 4.3 inches, 4.5 inches and 4.7 inches.

In detail, when the touch control module la receives the input event (such as clicking the “4.7 inches” icon) at the third control area 146, the processing unit 1d generates an adjusting signal, and the size of the shrunken frame 12 is thus adjusted (such as adjusted from 4.5 inches to 4.7 inches, as shown in FIG. 5).

The control area 14 may be displayed in a graphic form or a text form, which is not limited herein.

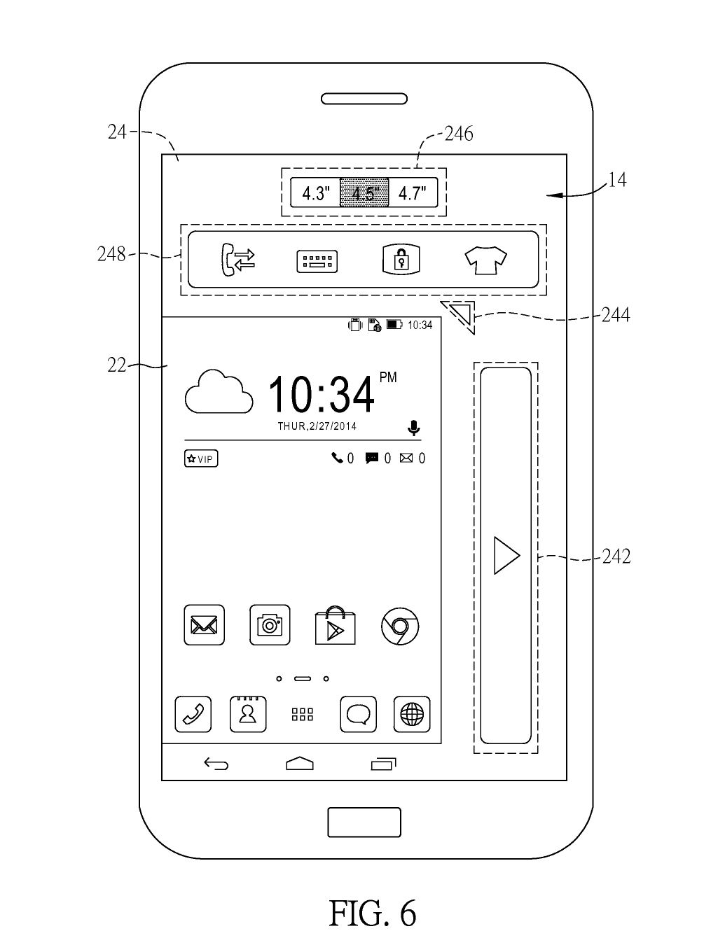

FIG. 6 is a schematic diagram showing a portable device and a graphic interface in the second embodiment.

In the embodiment, the arrangements of the third control area 248 and the first control area 242 are different from that in the previous embodiment, and a group of fourth control area 248 is further added. In the embodiment, the fourth control area 248 includes a plurality of shortcut keys.

Similarly, the GUI in the embodiment includes a shrunken frame 22 and a control area 24 surrounding the shrunken frame 22. The control area 24 includes a first control area 242, a second control area 244 and a third control area 246.

Compared with the previous embodiments, the first control area 242 is a long strip icon, and the icon of the second control area 244 is arranged at the edge of the shrunken frame 22. The shortcut icons in the fourth control area 248 may be preset by the manufacturer of the portable device, or can be adjusted by the user. The displaying frame of the shrunken frame 22 can directly be switched by pressing or clicking the shortcut icons.

The other configurations are similar with those in the previous embodiment, which is omitted herein.

In sum, a single-hand holding mode of the portable device is executed to switch the home frame displayed by the display module to the shrunken frame. It is more convenient for operating, executing an application program and inputting a command at the shrunken frame, and thus the portable device can be hold and operated by one single hand.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A portable device comprising:
a touch control module;
a display module connected to the touch control module, wherein the display module displays a home frame;
a memory module storing an application program; and
a processing unit connected to the touch control module and the memory module;
wherein when the application program is executed, the display module displays a shrunken frame and a control area, the control area surrounds the shrunken frame, and the shrunken frame shows a zoom-out home frame.

2. The portable device according to claim 1, wherein the control area further includes a first control area, the touch control module receives an input event at the first control area, the processing unit provides a switch signal according to the input event ,and a configuration of the shrunken frame and the control area is adjusted.

3. The portable device according to claim 1, wherein the control area further includes a second control area, the touch control module receives an input event at the second control area, the processing unit generates an exit signal according to the input event, and the display module displays the home frame.

4. The portable device according to claim 1, wherein the control area further includes a third control area, the touch control module receives an input event at the third control area, the processing unit generates an adjusting signal according to the input event, and a size of the shrunken frame is adjusted.

5. The portable device according to claim 1, wherein the control area is displayed in a text form or a text form or a graphic form.

6. The portable device according to claim 1, wherein the shrunken frame is displayed at a corner of a displaying frame of the portable device.

7. The portable device according to claim 2, wherein the first control area is a dominant hand switching area.

8. The portable device according to claim 3, wherein the second control area is a single-hand mode exiting area.

9. The portable device according to claim 4, wherein the third control area is a frame size adjusting area.

10. The portable device according to claim 1, wherein the control area further includes a fourth control area, and the fourth control comprises a plurality of shortcut keys.
